(19) United States
(12) Patent Application Publication
(10) Pub. No.: US 2004/0258815 A1
(43) Pub. Date: Dec. 23, 2004

(54) Method for making improved garlic product by freezing

(76) Inventor: Tony S. Zaboli, Marietta, GA (US)

Correspondence Address: GOLDMAN IP LAW, JOEL S. GOLDMAN, 2859 PACES FERRY ROAD, SUITE 700, ATLANTA, GA, 30339, US

(21) Appl. No.: 10/602,182

(22) Filed: Jun. 23, 2003

(51) Int. Cl. A23P 1/00

(52) U.S. Cl. 426/486

(57) ABSTRACT

A method of processing fresh garlic to remove the characteristic odor it produces after ingestion is described. The method includes the steps of saturating the garlic in a water-based fluid and then thawing the garlic.

### BACKGROUND OF THE INVENTION

1. Field of the Invention

The present invention generally relates to a method for processing fresh garlic to render it odorless after ingestion and to provide for its long term preservation, and more particularly, to a process which uses the expansion property of water put below its freezing point to rupture the micrograms of aromatic oils contained within cloves of garlic without cooking the clove or substantially varying its freshness and texture.

2. Description of Background Art

Garlic has been used for food for a long time for the purposes of nutrition, medical use, flavoring, etc. However, the range of its utilization for food has been somewhat limited because of its strong odor and such odor's lasting effects on those who consume the garlic. Various methods have been described in the art to remove odor from garlic.

These prior art methods can be characterized in several groups. One group acts by removing garlic odor constituents by treatment using enzymes or agents. This can be accomplished with a fermentation product such as per JP 2894/1960; JP 14,392/1963 and JP 27,308/1967; treatment using agents such as pyroligenous acid as per JP 19,936/1975; an aqueous solution of acetic acid as per JP 130,455/1978; phytic acid and silic acid sol as per JP 29,265/1982; and a menthol containing solution as per JP 13,964/1989, etc.

Another group acts by forcibly removing garlic odor constituents by treating garlic water extract with resins, active carbon or steam as per JP 210,864/1984 and JP 100,259/1987, including extraction with alcohol and the like, etc.

Still another group comprises deodorizing garlic by inactivating allinase, an enzyme involved in the formation of garlic odor, by heat inactivating the enzyme with a hot blast of gas as per JP 77,560/1975; steam cooking as per JP 198,065/1982; boiling as per JP 115,947/1967 and JP 12,658/1966; treatment using oil at a high temperature as per JP 28,658/1973; baking as per JP 265,862; and electromagnetic wave heating as per JP 18,568/1973, JP 48,862/1974 and JP 64,762/1981, etc.

Finally, the present inventors of U.S. Pat. No. 6,468,751 and U.S. Pat. No. 6,197,354 describe a process of rupturing the micrograms or cells of aromatic odor present in fresh garlic by microwave energy so that the aromatic oils are released allowing them to be neutralized by cooking or digestion.

Unfortunately, the heating of garlic by microwave means, or other means, may cause other undesirable chemical changes in the garlic which could modify or reduce the benefits provided by the ingestion of fresh garlic.

A need exists, therefore, for a process which can eliminate the unpleasant odor of garlic after ingestion while at the same time avoiding undesirable chemical changes to garlic which may reduce its beneficial effects.

### SUMMARY OF THE INVENTION

The invention pertains to a process to render garlic non-offensive after it has been eaten. Garlic is composed of many tiny micrograms or capsules containing the aromatic oils which cause such odors. Presently, the odors are produced by garlic, even after cooking and eating, because all of the tiny micrograms of garlic have not been ruptured and thus do not allow neutralizations of the oils either by cooking and/or digestion.

In accordance with the invention, fresh garlic is processed so that it will not leave an unpleasant odor after having been digested. The fresh garlic can be peeled, unpeeled, minced or chopped prior to processing. Garlic is composed of many tiny micrograms containing aromatic oils that are responsible for its strong odor. It has been determined that with the correct processing of the fresh garlic by internal freezing that most, if not all, of the tiny micrograms can be ruptured without affecting and/or changing the chemical composition or intensity of useful ingredients of garlic. This process preserves the content of micrograms in original form so that the aromatic oils can be easily neutralized without changing the fresh flavor and texture of garlic.

In accordance with the invention, fresh garlic, peeled or unpeeled, is saturated in a water-based fluid at 0° C. for periods of one hour to sixty hours. A vacuum may be applied to decrease saturation time. Liquids which have been found to be useful for use for saturation of the garlic are pure boiled water, boiled water and vinegar, and/or boiled water and lemon juice in natural concentration. In addition, edible salts can also be added during the process to control freezing point and adjust taste, or as a preservative.

After the garlic is properly saturated, it is frozen then by conventional freezing or flash freezing. The traditional freezing method takes place slowly, allowing water vapor to migrate between cells and form large, sharp needle-like ice crystals that damage garlic micrograms. By using flash freezing, which is an accelerated method of freezing using ultra low temperatures, smaller ice crystals will form and there will not be time for vapor migration, therefore reducing membrane damage in garlic. However, the process of expansion and contraction caused by the freezing and thawing of the water-based liquid contributes to the rupture of the micrograms.

After the freezing process, the processing liquid may be thawed, and poured off, and new or different liquids form the group of water, soluble oil, lemon juice or vinegar may be used to replace the processing liquid as a storage liquid.

Alternatively, the fresh garlic cloves can be minced or chopped prior to or after processing.

The garlic processed by this method is best used the same way fresh garlic is used. Processed in a liquid and salted, the fresh garlic exhibits extended shelf life.

These and other objects, aspects and features of the invention will be more clearly understood and better described when the following detailed description is read.

### DETAILED DESCRIPTION OF THE PREFERRED EMBODIMENT

In general, the process of the invention includes the steps for providing fresh garlic in bulbs or other similar forms having a plurality of cloves containing a multitude of micrograms enclosing the aromatic oils of the garlic, saturating the garlic in a water-based fluid and freezing the saturated garlic.

The following liquids have been found to be suitable for use in saturating the garlic: pure boiled water, boiled water and vinegar, boiled water and lemon juice, and lemon juice in natural concentration. It is believed that any water-based liquid would be useful for performing the step of saturating the garlic. In addition, other substances, such as edible salts, may be added to the liquid before or during the freezing process to control the freezing point (temperature at which the liquid freezes), and/or the adjustment of the taste, and/or to act as a preservative.

In the examples of the inventive process set forth below, two methods of freezing were used: conventional freezing and flash freezing. In the traditional freezing method, freezing occurs relatively slowly, allowing water vapor to migrate between cells and form large sharp needle-like ice crystals that damage the garlic micrograms. The second method is “flash freezing.” This is an accelerated method of freezing using ultra low temperatures (e.g., below 0° C.). Using the flash freezing method, smaller ice crystals form, and there is little or no water vapor migration, thereby reducing membrane damage to the garlic; however, the expansion of the water in the garlic upon freezing still contributes to the rupture of the micrograins. Using both methods of freezing, the effect of time and temperature was studied to discover the most efficient method for producing garlic which is odorless after ingestion and digestion. Testing for effectiveness was done by having one or more subjects ingest a sample and having another subject(s) determine whether an odor was present after ingestion.

Time and Temperature

In both methods of freezing, the effects of time and temperature were studied to discover the most efficient method.

TABLE 1

| Temperature | Freezing Time | Freezing Time | Freezing Time | Freezing Time | Freezing Time |
|---|---|---|---|---|---|
| (° C.) | (2 hours) | (6 hours) | (12 hours) | (24 hours) | (48 hours) |
| −2 | OK | OK | OK | OK | OK |
| −5 | OK | OK | OK | OK | OK |
| −10 | OK | OK | OK | OK | OK |
| −15 | OK | OK | OK | OK | OK |
| −20 | OK | OK | OK | OK | OK |
| −25 | OK | OK | OK | OK | OK |
| −30 | OK | OK | OK | OK | OK |

### EXAMPLE 1

Fresh garlic was peeled and 235 grams of cloves were saturated in 210 grams of a water-based liquid in a plastic container. Seven containers were prepared this way. The containers were then transferred to freezer, and the temperature was reduced to varying degrees from −2° C. to −30° C., and varying time durations from two to forty-eight hours. After defrosting, the garlic was tested, and the results were acceptable and tabulated in Table 1.

### EXAMPLE 2

Fresh garlic was peeled and 235 grams of cloves were saturated in 210 grams of a water-based liquid in aplastic container. Then, garlic was drained. Seven containers were prepared this way and were tested in different temperatures and duration of freezing. After defrosting, the garlic was tested, and the results were acceptable and tabulated in Table 1.

### EXAMPLE 3

Same procedure as Example 1 was performed, but garlic was vacuum-packed before transferring to freezer. After defrosting, the garlic was tested, and the results were acceptable and tabulated in Table 1.

### EXAMPLE 4

Same procedure as Example 2 was performed, but garlic was vacuum-packed before transferring to freezer. After defrosting, the garlic was tested, and the results were acceptable and tabulated in Table 1.

### EXAMPLE 5

Same procedure as Example 1 was performed, but the liquid was an oil-based liquid. After defrosting, the garlic was tested, and the results were acceptable and tabulated in Table 1.

### EXAMPLE 6

Same procedure as Example 2 was performed, but the liquid was an oil-based liquid. After defrosting, the garlic was tested, and the results were acceptable and tabulated in Table 1.

### EXAMPLE 7

Same procedure as Example 3 was performed, but the liquid was an oil-based liquid. After defrosting, the garlic was tested, and the results were acceptable and tabulated in Table 1.

### EXAMPLE 8

Same procedure as Example 4 was performed, but the liquid was an oil-based liquid. After defrosting, the garlic was tested, and the results were acceptable and tabulated in Table 1.

### EXAMPLE 9

Fresh garlic was peeled and 235 grams of cloves were saturated in 210 grams of a water-based liquid in a plastic container. Seven containers were prepared and were transferred to freezer and tested in different temperatures and duration of freezing. After defrosting, the garlic was tested, and the results were acceptable and tabulated in Table 1.

### EXAMPLE 10

Same procedure as Example 9 was performed, but garlic was vacuum-packed before transferring to freezer. After defrosting, the garlic was tested, and the results were acceptable and tabulated in Table 1.

TABLE 11

| Temperature | Freezing Time | Freezing Time | Freezing Time | Freezing Time | Freezing Time |
|---|---|---|---|---|---|
| (° Celsius) | (10 minutes) | (20 minutes) | (30 minutes) | (60 minutes) | (120 minutes) |
| −10 | OK | OK | OK | OK | OK |
| −15 | OK | OK | OK | OK | OK |
| −20 | OK | OK | OK | OK | OK |
| −30 | OK | OK | OK | OK | OK |
| −40 | OK | OK | OK | OK | OK |
| −50 | OK | OK | OK | OK | OK |
| −60 | OK | OK | OK | OK | OK |

### EXAMPLE 11

Fresh garlic was peeled and 235 grams of cloves were saturated in 210 grams of a water-based liquid in a plastic container. Seven containers were prepared this way. The containers were then flash frozen, and the temperature was reduced to varying degrees from −10° C. to −60° C. in time intervals of ten to one hundred twenty minutes. After defrosting, the garlic was tested, and the results were acceptable and tabulated in Table 11.

### EXAMPLE 12

Same procedure as Example 11 was performed, except that the garlic containers were drained prior to freezing. After defrosting, the garlic was tested, and the results were acceptable and tabulated in Table 11.

### EXAMPLE 13

Same procedure as Example 11 was performed, except that the garlic containers were vacuum-packed prior to freezing. After defrosting, the garlic was tested, and the results were acceptable and tabulated in Table 11.

### EXAMPLE 14

Same procedure as Example 12 was performed, except that the garlic containers were vacuum-packed prior to freezing. After defrosting, the garlic was tested, and the results were acceptable and tabulated in Table 11.

### EXAMPLE 15

Fresh garlic was peeled and 235 grams of cloves were put in a plastic container. Seven containers were prepared this way. The containers were then flash frozen, and the temperature was reduced to varying degrees from −2° F. to −80° F. in time intervals of ten to one hundred twenty minutes. After defrosting, the garlic was tested, and the results were acceptable and tabulated in Table 11.

### EXAMPLE 16

Same procedure as Example 11 was performed, but the liquid was an oil-based liquid. After defrosting, the garlic was tested, and the results were acceptable and tabulated in Table 11.

The conclusion derived from the above examples was the primary factor for rupturing garlic micrograms is water molecules in garlic, which is the only fluid which expands when it freezes, and, as a result, it ruptures the micrograms. The amount of water content in garlic is the most important factor in freezing and rupturing the micrograms. As the water molecules freeze, they expand. At the same time, non-water molecules in garlic contract, increasing the intensity of the micrograin rupture. Some of the micrograins start rupturing based on the water content immediately after freezing of water. In other cases, rupture occurs at temperatures that cause non-water molecules to freeze. This is the secondary rupture. This secondary rupture is caused by contraction. It was also observed that the shape of the water crystals on conventional method of freezing having sharper edges contribute to the rupture of the micrograms. In flash freezing technique, the shape and size of water molecules being smaller and not as sharp reduce the damage to the garlic micrograms. However, the process of expansion and contraction contribute to the rupture of the micrograms.

While the invention has been described in connection with its preferred embodiments, this specification is not intended to limit the scope of the invention to the particular forms set forth, but, on the contrary, it is intended to cover any such alternatives, modifications, and equivalents as may be included within the spirit and scope of the invention as defined by the appended claims.

What is claimed is:

1. A method of processing fresh garlic to remove the characteristic odor after it has been ingested, comprising the step of:
a) providing fresh garlic containing a multitude of micrograms enclosing the aromatic oils of garlic;
b) saturating the garlic in a water-based fluid;
c) freezing the saturated garlic.

2. The method of claim 1, further comprising thawing the frozen garlic.

3. The method of claim 1, wherein said water-based liquid is selected from the group consisting of:
a) pure boiled water;
b) boiled water and vinegar;
c) boiled water and lemon juice; and
d) lemon juice in natural concentration.

4. The method of claim 1, further comprising adding one (1) or more edible salts to the water-based fluid prior to said freezing step;

5. The method of claim 1, wherein said freezing step is accomplished by subjecting the saturated garlic to an ambient temperature of between 0° C. and −60° C.;

6. The method of claim 1, wherein said freezer step is accomplished by submitting the saturated garlic to an ambient temperature of lower than 0° C.;

7. The method of claim 1, wherein said saturation step is performed at approximately 0° C.;

8. The method of claim 1, wherein said saturation step is performed at least partially in a vacuum.
